(19) United States
(12) Patent Application Publication
(10) Pub. No.: US 2014/0252866 A1
(43) Pub. Date: Sep. 11, 2014

(54) PRESENCE AND RANGE DETECTION OF WIRELESS POWER RECEIVING DEVICES AND METHOD THEREOF

(71) Applicants: Jim Walsh, Santa Clara, CA (US); Joshua R. Smith, Seattle, WA (US); Issy Kipnis, Berkeley, CA (US)

(72) Inventors: Jim Walsh, Santa Clara, CA (US); Joshua R. Smith, Seattle, WA (US); Issy Kipnis, Berkeley, CA (US)

(21) Appl. No.: 13/976,698

(22) PCT Filed: Mar. 11, 2011
(86) PCT No.: PCT/US2011/059055

§ 371 Date: Dec. 26, 2013

(51) Int. Cl. H01F 38/14

(52) U.S. Cl. CPC H01F 38/14
USPC 307/104

(57) ABSTRACT

In accordance with various aspects of the disclosure, a wireless power transmitting apparatus, system, and method are presented that include features of detecting a forward power level and a reflected power level of an electromagnetic field in which a wireless transmit device is capable of determining the presence of a wireless receive device based on the detected reflected power levels.

### BACKGROUND

This disclosure relates generally to the field of power transmission, and in particular, to a method and apparatus for wirelessly transmitting and receiving power.

Recent advances in wireless power/energy transfer systems, especially resonance-based technologies, have made the wireless transfer of power more efficient over longer distances. In an effort to improve the overall operational efficiency of such systems, current wireless systems employ schemes capable of detecting the presence of resonant-compatible receiving devices as well as detecting the power transfer efficiency between the transmitting source and receiving devices. However, current systems impose some of the detection functionality on the receiving devices, thereby increasing costs and complexity of such devices.

### BRIEF DESCRIPTION OF THE DRAWINGS

FIG. 1 depicts shows an exemplary system concept diagram of wireless power transmission system, in accordance with various aspects of the present disclosure.

FIG. 2 depicts a functional block diagram of a transmitter subsystem and a processor transmitter interface subsystem, in accordance with various aspects of the present disclosure.

FIG. 3 depicts a functional block diagram of a receiver subsystem and receiver power subsystem, in accordance with various aspects of the present disclosure.

FIG. 4 depicts a functional block diagram of transmitter analog circuitry, in accordance with various aspects of the present disclosure.

FIG. 5 depicts a functional block diagram of receiver timer and switch calibration circuit, in accordance with various aspects of the present disclosure.

FIG. 6 depicts a characteristic response of reflected power vs. forward power, in accordance with various aspects of the present disclosure.

FIG. 7A depicts a flowchart of the transmitter aspects of a process to detect the presence and range of a wireless receiver.

FIG. 7B depicts a flowchart of the receiver aspects of a process to detect the presence and range of a wireless receiver.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, a wireless power transmitting apparatus is presented that includes a power detection module configured to detect a forward power level and a reflected power level of an electromagnetic field and detects the presence and range of a wireless receiver based on detected reflected power levels.

In accordance with other embodiments of this disclosure, a wireless power transmitting system is presented that includes a transmit device, a power detection module configured to detect a forward power level and a reflected power level of a transmitted field and detects, at the wireless power transmission source, the presence and range of a wireless receiver based on detected reflected power levels.

In accordance with various embodiments of this disclosure, a wireless power transfer method is presented that detects, at the wireless power transmission source, the presence and range of a wireless receiver based on detected reflected power levels. In some embodiments, the presence and range may be based on a combination of detected forward and reflected power levels.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

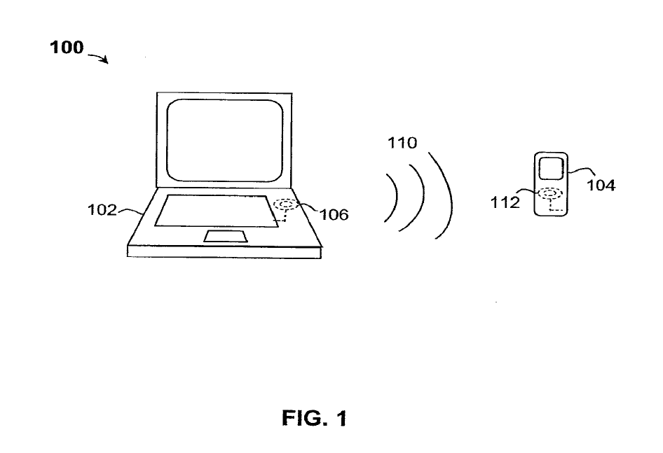

Turning now to the various aspects of the disclosure, FIG. 1 depicts an exemplary diagram representing wireless transmission environment 100, in accordance with various exemplary embodiments of the present disclosure. A wireless transmitting source, such as, for example, wireless host computing device 102, transmits power to a wireless receiving destination, such as, for example, wireless receiving device 104. The transmitted power is wirelessly conveyed via an electromagnetic field generated by transmitter antenna 106, represented by arcuate curves 110 in FIG. 1, that is received by receiver antenna 112. In one embodiment, wireless host computing device 102 and wireless receiving device 104 are configured to have a mutually compatible resonant relationship, namely, the resonant frequency of wireless receiving device 104 corresponds to the resonant frequency of wireless host computing device 102.

By way of illustration only, and in no way limiting, wireless host computing device 102 is represented as a laptop and wireless receiving device 104 is illustrated as a cellular phone. However, as can be contemplated by one of ordinary skill in the art after reading this disclosure, wireless host computing device 102 may be a desktop personal computer (PC) or standalone wireless charging device not integrated with other equipment, while wireless receiving device 104 may be a computing devices (e.g., a personal digital assistant or PDA device), a mobile computing device (e.g., a smart-phone with computing capabilities), or other device/appliance configured with wireless power reception capabilities.

It will also be appreciated that, although one wireless host computing device 102 and one wireless receiving device 104 are shown in environment 100 of FIG. 1, various aspects of the disclosure can relate to other number of wireless host computing devices and receiving devices, as can be contemplated by one of ordinary skill in the art after reading this disclosure. For example, environment 100 may have one wireless host computing device transmitting power to two or more wireless receiving devices. Alternatively, a network of plurality of wireless host computing devices and wireless receiving devices may be used in environment 100 for the wireless transmission and reception of power, such that each of the wireless host computing devices and receiving devices may be a node in such a network system.

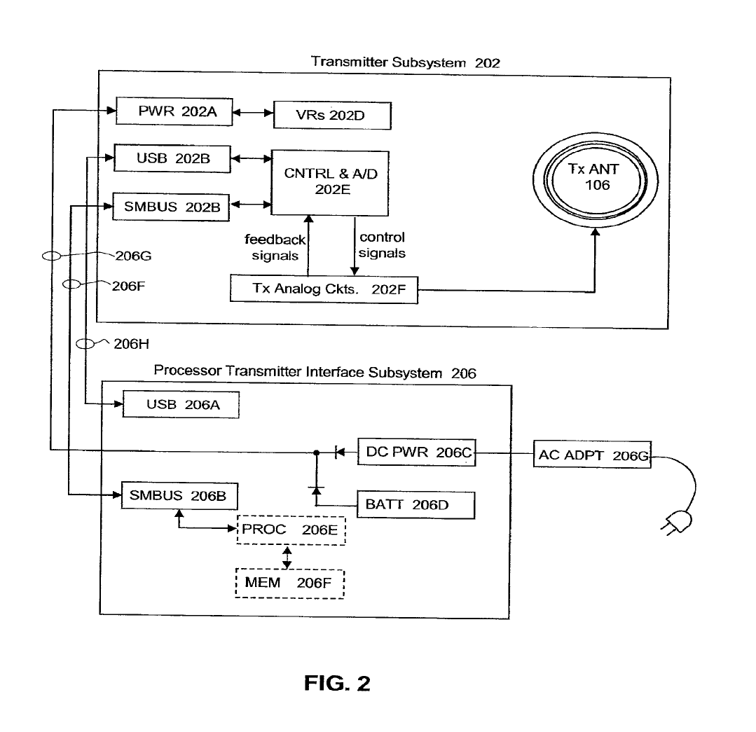

FIG. 2 depicts a functional block diagram of an exemplary transmitter subsystem 202 and processor transmitter interface subsystem 206 of wireless host computing device 102, in accordance with various exemplary embodiments of the present disclosure. The processor transmitter interface subsystem 206 operates under the control of processor or controller 206E of wireless host computing device 102 and controls the configuration of various transmitting parameters of transmitter subsystem 202, based upon one or more transmission policies stored in memory 206F of host computing device 102. Such policies may include operating rules, such as, only transmit power when AC power is present, only transmit power when battery is engaged, limit transmit power based on heat detection, terminate power transmission when detected battery power is below a predetermined threshold, etc. Once configured transmitter subsystem 202 functions autonomously and is not dependent on other software or hardware to transmit power.

Processor 206E may be one or more microprocessors or microcontrollers such as those made by Intel Corporation of Santa Clara, Calif. (although other vendors may be used). In one example, processor 206E may form a compute complex on a circuit board and may include one or more microprocessor units, or any other combination of logic circuits capable of executing the functionality and methodologies of wireless host computing device 102 as described herein below.

Memory 206F coupled to processor 206E may be one or more of the following types of memory: SRAM; BSRAM; or EDRAM. Other examples include the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing functionality and methodologies described herein below.

Communication between processor transmitter interface subsystem 206 and transmitter subsystem 202 is achieved via a bus infrastructure. In one embodiment, processor transmitter interface subsystem 206 delivers configuration, control, status, and power-related information to transmitter subsystem 202 through bus infrastructure comprising buses 206F, 206G, and 206H. That is, bus 206H (e.g., USB) may be configured to convey configuration and control information and bus 206F (e.g., SM Bus) may be configured to convey battery and charging status information to the transmitter subsystem 202 controller 202E, while bus 206G may be configured to supply power to transmitter subsystem 202. Although various bus configurations have been described, it should be understood that other types of serial or parallel buses known to one of ordinary skill in the art may be used.

Because wireless host computing device 102 may, itself, be powered by an external source or battery, processor transmitter interface subsystem 206 includes power coupler 206C as well as battery 206D. Power coupler 206C receives a regulated DC voltage signal from AC adapter 206G that connects to an external AC power supply. It will be appreciated that AC adapter 206G may include transformer circuits, rectifying circuits, and other circuitry to ensure a proper DC voltage signal level, as can be contemplated by one of ordinary skill in the art.

The DC voltage signal, from either power coupler 206C or battery is supplied to transmitter subsystem 202 via bus 206G to power coupler 202A. The DC voltage signal is then regulated by voltage regulator(s) 202D of transmitter subsystem 202 to account for any variations due to coupling and battery output voltage, and ensure a constant DC voltage signal level.

As noted above, controller 202E of transmitter subsystem 202 receives configuration, control information, and status information via buses 206F, 206H. In turn, controller 202E provides control signals to, and receives feedback signals from, transmit analog circuitry 202F. Controller 202E may be one or more microprocessors or microcontrollers such as those made by Intel Corporation of Santa Clara, Calif. (although other vendors may be used). Transmit analog circuitry 202F, described in more detail below, operates to energize transmit antenna 106 in accordance with the control signals provided by controller 202E.

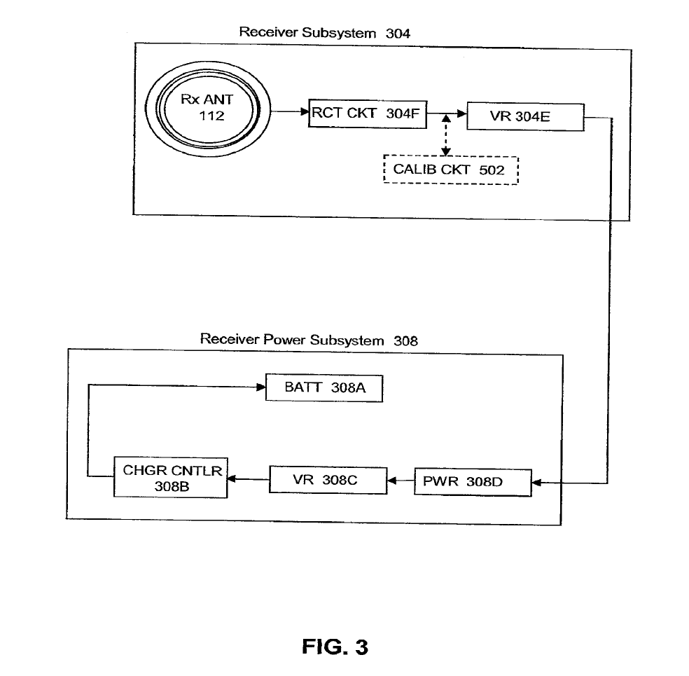

Turning to the receiving side, FIG. 3 depicts a functional block diagram of an exemplary receiver subsystem 304 and receiver power subsystem 308 of wireless receiving device 104, in accordance with various exemplary embodiments of the present disclosure. The transmitted power wirelessly conveyed by transmitter antenna 106, via field 110, is received by receiver antenna 112 of subsystem 304. As with transmitter antenna 106, receiver antenna 112 may comprise one or more of a coil antenna, helical antenna, a dipole antenna, a monopole antenna, a loop antenna, a patch antenna, a slot antenna, a Planar Inverted “F” (PIFA) antenna, and other types of antennas of suitable geometry and electrical properties depending upon specific transmission parameters associated with the power reception by wireless receiving device 104.

Receiver antenna 112 is coupled to a rectifier circuit 304F that converts the received energy into a DC voltage signal. Rectifier circuit 304A may comprise a full wave rectifying circuit, such as, for example, a bridge rectifier, or other circuitry suitable for such purposes. The DC voltage signal is then regulated by voltage regulator 304E to provide a regulated and constant DC voltage signal level.

The regulated DC voltage signal is provided to receiver power subsystem 308 via power coupler 308D and is then regulated again by voltage regulator 308C to account for any variations due to coupling and ensure a constant DC voltage signal level. The constant DC voltage signal is then provided to a charger controller 308B to control the charging voltage supplied to battery 308A. The charger controller 308B may comprise a processor, DC/DC converter(s), timing circuit(s), trickle charge circuit(s), protection circuit(s), and other circuitry to ensure the proper charging of battery 308A, as can be contemplated by one of ordinary skill in the art after reading this disclosure.

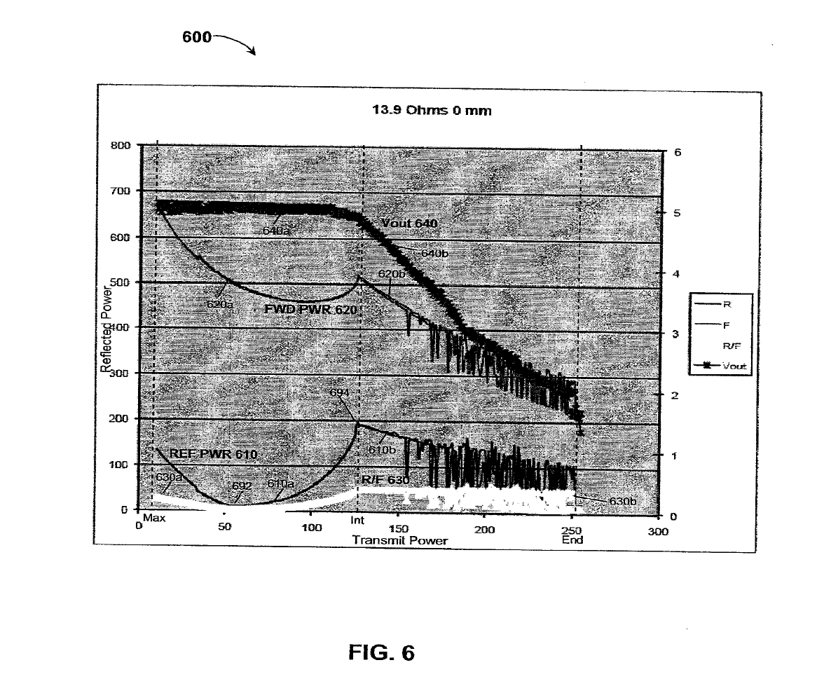

Receiver subsystem 304 may further include a timer and switch calibration circuit 502. In some embodiments and as discussed in more detail below (see, FIG. 5), for the wireless host computing device 102 to adequately detect the presence and range of wireless receiving device 104 and ameliorate introductory nonlinear variances caused by voltage regulator 304E, timer and switch calibration circuit 502 operates to present a predetermined fixed resistive load during an initial calibration time interval. Since the transmit power level and receive fixed load is known for this time interval, the presence of wireless receiving device 104 and the spatial distance between the receiving device 104 and wireless host computing device 102 can be determined.

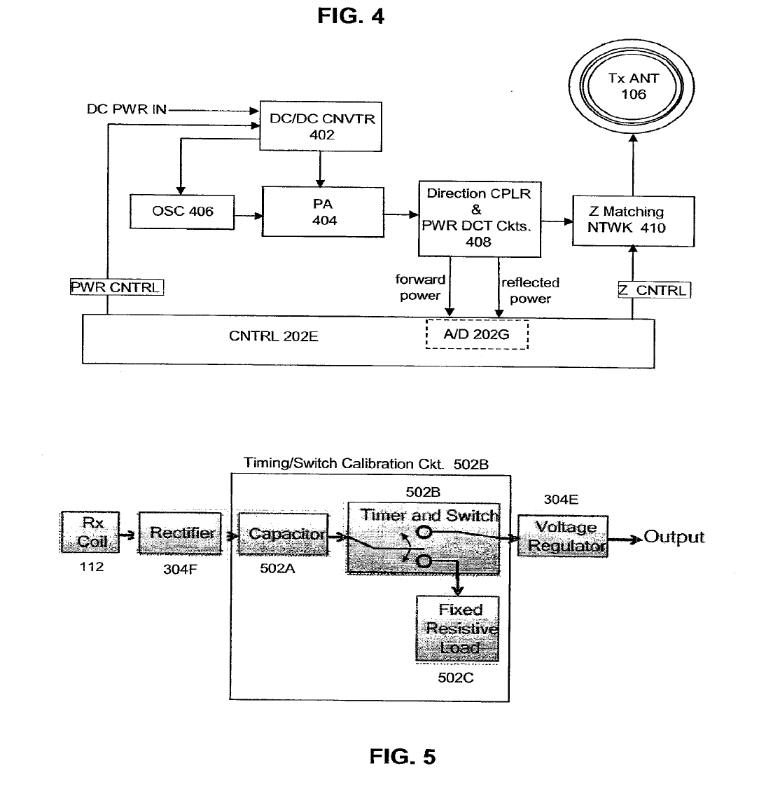

As noted above, transmit analog circuitry 202F of transmitter subsystem 202 operates to energize transmit antenna 106 in accordance with control signals provided by controller 202E. FIG. 4 depicts a detailed functional block diagram of transmit analog circuitry 202F. In accordance with various embodiments of the present disclosure, transmit analog circuitry 202F comprises DC/DC converter circuitry 402, power amplifier 404, oscillating circuit 406, directional coupler and power detection circuitry 408, and impedance matching circuitry 410.

The DC/DC converter circuitry 402 provides a DC voltage signal at a constant or stable voltage level (e.g., 5 volts) to oscillator 406, and provides a DC signal with variable voltage (in accordance with control signals generated by controller 202E) to power amplifier 404. The DC voltage drives both oscillator 406 and power amplifier 404. For example, based on the inputted DC voltage, oscillator 406 generates a radio-frequency (RF) signal operating at a predetermined RF frequency (e.g., 13.5 MHz), while power amplifier 404 adjusts (e.g., steps up) the power level of the radio-frequency (RF) signal in accordance with the variable voltage of the received DC signal (e.g., to a maximum predetermined amount (e.g., 15 W)).

In turn, power amplifier 404 inputs a power signal to directional power coupler and power detector circuitry 408. It will be appreciated that transmit power is a function of power conveyed in a forward direction (i.e., forward power) from the transmission source and power reflected back (i.e., reflected power) towards the transmission source due to impedance mismatches. As such, the power directional coupler portion of circuitry 408 separates the power signal into a forward power signal and a reflected power signal. The power detector portion of circuitry 408 detects the levels of separated forward power and reflected power signals and converts the detected levels of forward power and reflected power into voltage signals. These voltage signals are supplied to A/D converter(s) 202G to generate DC voltage information representative of the forward power and reflected power levels to be processed by controller 202E.

Armed with the voltage information representing the forward power and reflected power levels, controller 202E functions to adjust and control the output power of power amplifier 404 by changing the operating voltage of the power amplifier 404 via a power control signal provided to DC/DC converter 402. Controller 202E also functions to adjust and control the tuning of impedance matching network 410 via an impedance control signal provided to impedance matching network 410. In one embodiment, controller 202E adjusts the output power transmitted as well as tunes the impedance, based on the detected level of reflected power. That is, controller 202E exploits the reflected power levels to estimate what current load is being drawn by wireless receiving device 104. For example, the current load being drawn by receiving device 104 indicates a certain load impedance, and controller 202E operates to adjust power amplifier 404 and impedance matching network 410 accordingly.

In accordance with various embodiments of the present disclosure, the configuration of transmit analog circuitry 202F of transmitter subsystem 202 enables the detection, at the wireless host computing device 102, of the presence and range of wireless receiving device 104, based on reflected power levels. As noted above, transmitted power levels are a function of both forward power and reflected power levels. In turn, reflected power is a function of impedance changes along the power signal's transmission path. Thus, in the disclosed wireless transmission environment 100, if wireless receiving device 104 is not present, then a high impedance is presented and the majority of the transmitted power signal is reflected back toward wireless host computing device 102.

Conversely, if wireless receiving device 104 is present, then less of the transmitted power signal is reflected back toward wireless host computing device 102. The amount of how much is reflected back is related to: (a) the distance (e.g., in X/Y/Z directions) and spatial orientation of receive antenna 112 with respect to transmit antenna 106; and (b) the load (i.e. power draw) of wireless receiving device 104.

In some embodiments, the uncertainty of what load a particular wireless receiver device 104 may possess, is obviated by providing timer and switch calibration circuit 502 in receiver subsystem 304, as depicted in FIG. 5. Timer and switch calibration circuit 502 may be interposed between voltage rectifier 304F and voltage regulator 304E of receiver subsystem 304. During an initial calibration time interval (e.g., 0.1 ms, 10 ms, 100 ms, etc.), the rectified AC voltage charges capacitor 502A to provide a DC voltage signal and switch 502B operates to couple a predetermined, fixed resistive load 502C by supplying the DC voltage signal to resistive load 502C and decoupling voltage regulator 304E.

During this initial calibration time interval, the wireless host computing device 102 transmits a power signal and wireless receiver device 104 operates to present the fixed resistive load. Because the transmit power level and receive fixed load are known for this time interval, the presence wireless receiving device 104 and the spatial distance between the receiving device 104 and wireless host computing device 102 can be determined by sensing the reflected power, as discussed in more detail below. It will also be appreciated that, by decoupling voltage regulator 304E in receiver subsystem 304, timer and switch calibration circuit 502 also serve to ameliorate introductory nonlinearities caused by voltage regulator 304E.

After the initial calibration time interval has lapsed, timer and switch calibration circuit 502 switches connectivity to re-couple voltage regulator 304E for normal wireless power transfer operations of receiver device 104.

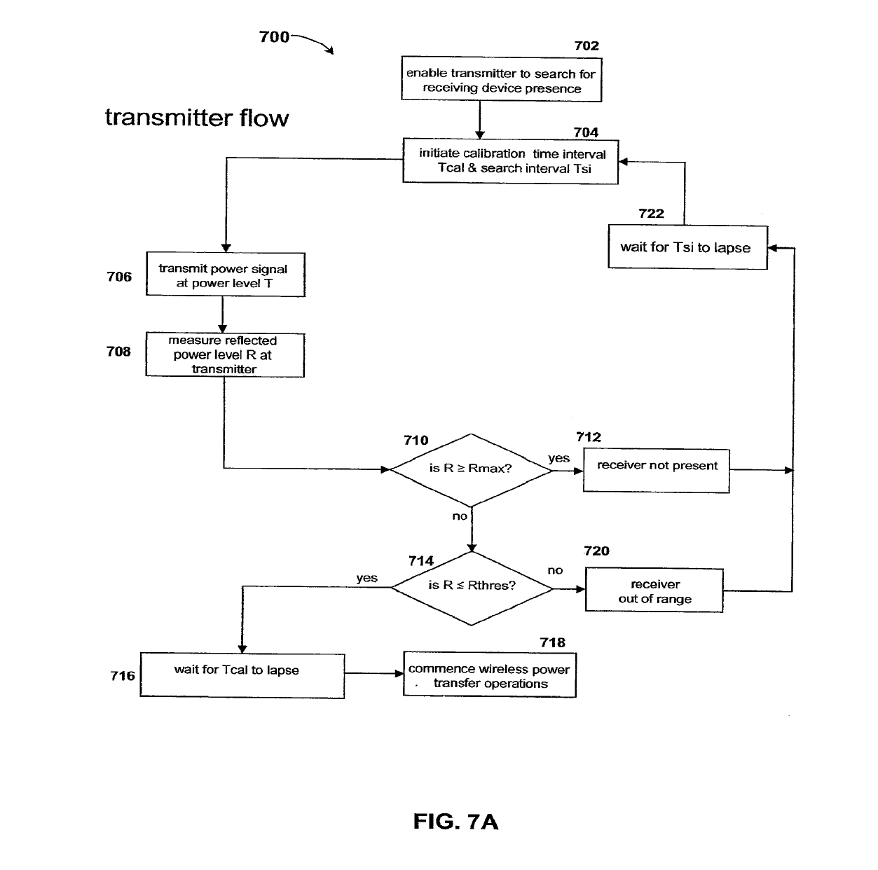

With regard to the relationship between reflected power levels and spatial distance, FIG. 6 depicts a characteristic response of reflected power vs. forward power for a range of transmit power levels for a given fixed resistive load and a particular spatial position (e.g., range and orientation with respect to device 102, transmitter 202 or transmitter antenna 106) of receiving device 104. In one non-limiting implementation, the fixed load is selected as 13.9 ohms, and the device position is chosen as 0 mm offset. As shown, plot 600 includes a range of transmit power levels (e.g., as controlled by controller 202E) on the x-axis ranging from values zero to 300, wherein each of those values is representative (and function) of a particular transmit power level, and as such, is not an actual transmit power level. Moreover, the x-axis represent the transmit power level in a decreasing order, i.e., from a maximum transmit power level represented by “0” to a minimum transmit power level represented by “300.” In accordance with one or more exemplary non-limiting configurations of transmitter subsystem 202 and/or controller 202E, the value “0” on the x-axis corresponds to a transmit power level equal to about 15 W. Further, the y-axis of plot 600 correspond to a range of reflected power levels, e.g., measured by directional power coupler portion and a power detector circuit portion 408. Similar to the x-axis values, the range of values from zero to 800 on the y-axis are representative (and function) of respective measured reflected power levels, and as such, those numbers are not the actual reflected power levels. However, the y-axis values correspond to an increasing range of reflected power levels, i.e., from a minimum measured reflected power level represented by “0” to a maximum reflected power level represented by “800.”

As shown in FIG. 6, plot 600 includes curve “R” 610 depicting change in reflected power level responsive to changing transmit power levels, curve “F” 620 depicting change in forward power level responsive to changing transmit power levels, curve “R/F” 630 depicting change in the ratio of reflected power level to forward power level responsive to changing transmit power levels, and curve “Vout” 640 depicting change in the output voltage at the fixed load of receiving device 104 responsive to changing transmit power levels. In some embodiments, performance data related to one or more above-mentioned curves are collected after an initial calibration period (discussed above), e.g., after receiving device 104 and/or receiver subsystem 304 configures the timer and switch module to switch from the fixed resistive load to the voltage regulator. As shown in FIG. 6, it has been observed that, for a first decreasing range of the transmit power levels from a maximum value (indicated by label “max”) to a lower transmit level corresponding to an intermediate point labeled “int” on the x-axis, the measured reflected power levels and forward power levels each exhibit a “U-shaped” curve, labeled as 610a and 620a, respectively. In other words, for decreasing transmit power levels from point “max” to point “int” (i.e., the “max-int” region), each of the reflected and forward powers are initially measured to be at a high level (e.g., R at about value 130, and F at about value 670 on the y-axis). The reflected and forward powers then decrease to a lowest “dip” point (e.g., R at about value 10, and F at about value 480 on the y-axis), and finally the measured powers increase to another high level (e.g., R at about value 200, and F at about value 505). The ratio performance illustrated by curve 630 also exhibits a similar “U-shaped” curve (although with a shallower dip point) in the max-int region. As is also shown in FIG. 6, for the transmit power levels in the max-int region, the load voltage Vout is measured as a constant maximum value, e.g., equal to 5V.

It has been further observed that, for a further decreasing range of transmit power levels, e.g., from the “int” point to an “end” point on the x-axis (the “int-end” region), the measured reflected power level, forward power level, the R/F ratio, and the output load voltage each decrease with the decreasing transmit power level within the int-end region (indicated by labels 610b, 620b, 630b, and 640b, respectively). Moreover, a significant portion of all those measured quantities are observed to be “noisy.”

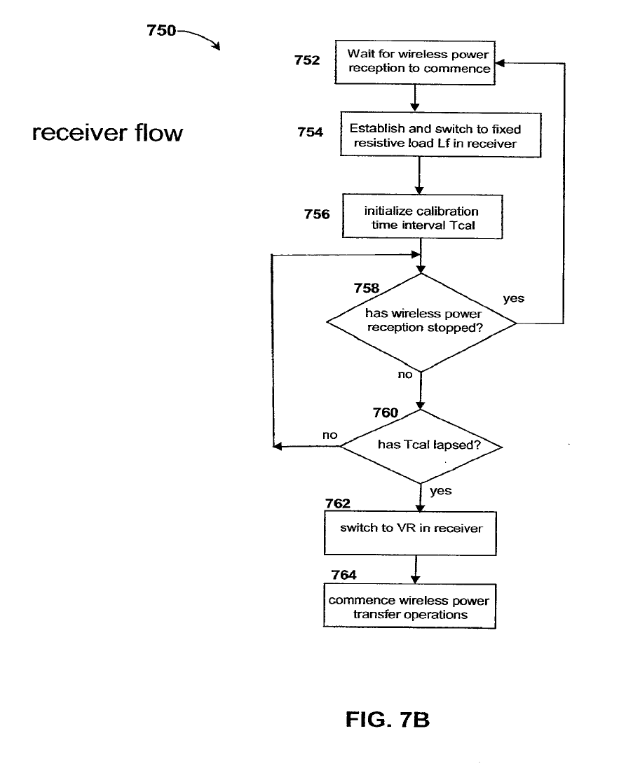

FIGS. 7A and 7B depict flow diagrams of processes 700 and 750, respectively, for detecting (at the wireless power transmission source and at the power reception side, respectively) the presence and range of a wireless receiver based on reflected power levels, in accordance with various exemplary embodiments of the present disclosure. It will be appreciated that processes 700, 750 may be implemented machine readable instructions for executing various operations carried out by wireless host computing device 102 and receiving device 104. The machine readable instructions may be implemented in software stored on tangible computer readable media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or implemented in firmware or dedicated hardware in a well known manner (e.g., it may be implemented by an application specific integrated circuit (ASIC), a programmable logic device (PLD), a field programmable logic device (FPLD), a field programmable gate array (FPGA), discrete logic, or the like).

Moreover, although processes 700, 750 is described with reference to the flowcharts of FIGS. 7A, 7B, respectively, persons of ordinary skill in the art will readily appreciate that many other methods of implementing the methods of transmitting and receiving by wireless host computing device 102 and receiving device 104, respectively, may alternatively be used. For example, the order of execution of the blocks in the depicted flowcharts may be changed, and/or some of the blocks described may be changed, eliminated, or combined.

Returning to FIG. 7A, process 700 begins at block 702, in which wireless host computing device 102 and/or transmitter subsystem 202 is enabled to search for the presence of receiving device 104.

At block 704, process 700 initiates an initial calibration time interval T_{cal} (e.g., 0.1 ms, 10 ms, 100 ms, etc.) and a search interval Tₛᵢ. During the initial calibration time interval T_{cal}, a predetermined, fixed resistive load L_{f} is established by wireless receiving device 104. Accordingly, switch calibration circuit 502B of receiver subsystem 304 switches from voltage regulator 304E to fixed resistive load 502C having a value of L_{f}. As discussed above, during time interval T_{cal}, receiving device 104 presents L_{f} as its load, regardless of its actual load during normal wireless power transfer operations.

At block 706, wireless host computing device 102 wirelessly transmits a power signal at power level T and, at block 708, wireless host computing device 102 measures the reflected power R that is reflected back towards host computing device 102 by virtue of directional power coupler and power detector circuitry 408.

Upon determining the reflected power level, process 700 at block 710 determines whether wireless receiving device 104 is present by comparing whether reflected power R is greater than or equal to a reflected power maximum value Rₘₐₓ. As noted above, when wireless receiving device 104 is not present, then a high impedance is presented and the majority of the transmitted power signal is reflected back toward wireless host computing device 102, represented by Rₘₐₓ. As such, if at block 710, R is determined to be greater than or equal to reflected power maximum value Rₘₐₓ, process 700 concludes that wireless receiving device 104 is not present, as indicated by block 712.

If R is determined that R is less than Rₘₐₓ, process 700 then determines whether R is greater than or equal to reflected power threshold value, Rₜₕᵣₑₛ at block 714. As discussed above, when both the predetermined fixed resistive load of wireless receiving device 104 and the power level transmitted by wireless host computing device 102 are known, the amount of reflected power detected corresponds to the spatial location of wireless receiving device 104 relative to wireless host computing device 102. For example, a higher reflected power level corresponds to a larger distance between wireless receiving device 104 and wireless host computing device 102. In addition, the amount power is reflected back is also an indication of overall power transfer efficiency, as larger distances correspond to lower power transfer efficiencies.

As such, reflected power threshold value, Rₜₕᵣₑₛ may be based on characteristic response data of reflected power vs. forward power for certain transmit power levels at a fixed resistive load, as discussed above relative to FIG. 6. Thus, if at block 714, it is determined that reflected power R is less than or equal to reflected power threshold value Rₜₕᵣₑₛ, process 700 determines that wireless receiving device 104 is both present and within range of wireless host computing device 102. Following such determination, process 700 waits for the initial calibration time interval T_{cal} to lapse (at block 716), and then, at block 718 of process 700, wireless host computing device 102 commences wireless power transfer operations toward detected receiving device 104. At the same time, as discussed below, calibration circuit 502B of receiver subsystem 304 switches back to voltage regulator 304E, for normal wireless power transfer operations between wireless host computing device 102 and receiving device 104.

Conversely, if at block 714, process 700 determines that reflected power R is not less than or equal to reflected power threshold value Rₜₕᵣₑₛ, process 700 concludes that receiving device 104 is out of range from wireless host computing device 102, as indicated by block 720.

If, in process 700, it is determined that receiving device 104 is not present (block 712), or is out of range (block 720), process 700 proceeds to block 722 in which process 700 waits for the search interval Tₛᵢ to lapse. After the search interval Tₛᵢ expires, process 700 continues to (re-) initiate the calibration time interval T_{cal} and the search interval Tₛᵢ, at block 704, and further completes other operations of process 700 as discussed above.

Returning to FIG. 7B, process 750 begins at block 752, in which receiving device 104 waits to commence, e.g., from host computing device 102. At block 754, a predetermined, fixed resistive load L_{f} is established by wireless receiving device 104. To that end, timer and switch calibration circuit 502B of receiver subsystem 304 is configured to switch from voltage regulator 304E to fixed resistive load 502C comprising value L_{f}.

At block 756, an initial calibration time interval T_{cal} (e.g., 0.1 ms, 10 ms, 100 ms, etc.) is initialized in synchronization with the initial calibration time interval T_{cal} initialized at wireless host computing device 102 (at block 704). At block 758, process 750 determines whether the wireless power reception at receiving device 104 has stopped. If it is determined that the wireless power reception has stopped, process 750 re-starts at block 752 waiting for the wireless power reception to re-start. Otherwise, if it is determined that the wireless power reception has not stopped, process 750 moves to block 760, in which it is determined whether the initial calibration time interval T_{cal} has expired.

If the initial calibration time interval T_{cal} has not lapsed, process 750 goes back to block 758 to re-check whether the wireless power reception has stopped. However, if it is determined that the initial calibration time interval T_{cal} has lapsed, calibration circuit 502B of receiver subsystem 304 switches back to voltage regulator 304E (block 762), for normal wireless power transfer operations between wireless host computing device 102 and receiving device 104 (block 764).

By virtue of the embodiments of the configurations and process disclosed herein, a wireless power transmission source is capable of detecting the presence and range of a wireless power receiving device in a wireless power transmission system based on measured reflected power levels. Such embodiments achieve the presence and range detection without any costly or complicated circuitry in the power receiving device while mitigating any non-linear affects generated by components of the receiving device. Moreover, the disclosed embodiments can be incorporated in the transmission policies of the transmission source to improve the overall efficiency of the wireless power transmission system.

Having thus described the novel concepts of the wireless power transmission system, it will be apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. The alterations, improvements, and modifications are intended to be suggested by this disclosure, and are within the spirit and scope of the exemplary aspects of this disclosure. Additionally, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

What is claimed is:

1. A wireless power transmitting apparatus, comprising:
a transmit antenna configured to generate an electromagnetic field;
a power detection module configured to detect a forward power level and a reflected power level, each of which being associated with the transmitted electromagnetic field;
a controller, coupled to the transmit antenna and power detection module, and configured to determine presence of a receiving device based on the detected reflected power level.

2. The wireless power transmitting apparatus of claim 1, wherein the controller determines the presence of the receiving device if the detected reflected power level is less than a first threshold level.

3. The wireless power transmitting apparatus of claim 2, wherein the controller determines that the receiving device is within range, if the detected reflected power level is less than or equal to a second threshold level that is less than the first threshold level.

4. The wireless power transmitting apparatus of claim 3, wherein the second threshold level is based on characteristic response data of reflected power and forward power at predetermined transmit power levels and at a predetermined fixed resistive load value.

5. The wireless power transmitting apparatus of claim 1, wherein the controller stores a value representing a predetermined fixed resistive load of the receiving device.

6. The wireless power transmitting apparatus of claim 1, wherein the controller determines the presence of the receiving device within an initial time interval.

7. The wireless power transmitting apparatus of claim 6, wherein the initial time interval is predetermined to about 100 μs, 10 μs, or 100 ms.

8. The wireless power transmitting apparatus of claim 6 wherein, upon determining that the receiving device is present, the controller commences power transfer operations after expiration of the initial time interval.

9. The wireless power transmitting apparatus of claim 1 further comprising being coupled to a host device via a communication bus infrastructure, wherein the host device comprises a processor and memory and is configured to control the wireless power transmitting apparatus in accordance with operational parameters and policies stored in memory.

10. A wireless power transmission system, comprising:
a transmit device including a transmit antenna configured to generate an electromagnetic field, a power detection module configured to detect a forward power level and a reflected power level, each of which being associated with the field, and a controller, coupled to the transmit antenna and power detection module; and
a receive device including a receive antenna configured to receive the electromagnetic field generated by the transmit antenna,
wherein the controller determines presence of the receiving device based on the detected reflected power level.

11. The wireless power transmission system of claim 10, wherein the controller determines the presence of the receive device if the detected reflected power level is less than a first threshold level.

12. The wireless power transmission system of claim 11, wherein the controller determines that the receive device is within range of the transmit device, if the detected reflected power level is less than or equal to a second threshold level that is less than the first threshold level.

13. The wireless power transmission system of claim 12, wherein the second threshold level is based on characteristic response data of reflected power and forward power at predetermined transmit power levels and at a predetermined fixed resistive load value.

14. The wireless power transmission system of claim 10, wherein the controller determines the presence of the receiving device within an initial time interval.

15. The wireless power transmission system of claim 14, wherein the receive device further comprises a switch and timing circuit configured to present a predetermined fixed resistive load value of the receive device during the initial time interval.

16. The wireless power transmission system of claim 14, wherein the initial time interval is predetermined to about 100 μs, 10 μs, or 100 ms.

17. The wireless power transmission system of claim 14 wherein, upon determining that the receive device is present, the controller commences power transfer operations after expiration of the initial time interval.

18. The wireless power transmission system of claim 1 further comprising a host device coupled to the transmit device via a communication bus infrastructure, wherein the host device comprises a processor and memory and is configured to control the transmit device in accordance with operational parameters and policies stored in memory.

19. A wireless power transfer method, comprising:
generating, by a transmit device, an electromagnetic field;
detecting a forward power level and a reflected power level, each of which being associated with the transmitted electromagnetic field;
determining, by the transmit device, presence of a receive device based on the detected reflected power level.

20. The wireless power transfer method of claim 19 further comprising:
providing a predetermined fixed resistive load value for the receive device;
determining the presence of the receiving device if the detected reflected power level is less than a first threshold level; and
determining that the receiving device is within range of the transmit device, if the detected reflected power level is less than or equal to a second threshold level that is less than the first threshold level, the second threshold level being based on characteristic response data of reflected power and forward power at predetermined transmit power levels and at a predetermined fixed resistive load value.
